(19) United States
(12) Patent Application Publication
(10) Pub. No.: US 2008/0133668 A1
(43) Pub. Date: Jun. 5, 2008

(54) MANAGING INTENDED GROUP MEMBERSHIP USING DOMAINS

(75) Inventors: CLINTON GENE LASCHKEWITSCH, Stewartville, MN (US); ROBERT MILLER, Rochester, MN (US); VICKI LYNN MOREY, Pine Island, MN (US); LAURIE ANN WILLIAMS, Rochester, MN (US)

Correspondence Address: IBM CORPORATION, INTELLECTUAL PROPERTY LAW;DEPT 917, BLDG. 006-1, 3605 HIGHWAY 52 NORTH, ROCHESTER, MN, 55901-7829, US

(73) Assignee: International Business Machines Corporation

(21) Appl. No.: 12/015,856

(22) Filed: Jan. 17, 2008

Related U.S. Application Data
(62) Division of application No. 09/918,746, filed on Jul. 31, 2001.

(51) Int. Cl. G06F 15/16

(52) U.S. Cl. 709/205

(57) ABSTRACT

System and method for managing membership of a group of jobs in a computing environment is provided. In one embodiment, a domain group, a set of interfaces to manage the domain group, and cluster-assigned member names to identify the members in a group is provided. The interfaces allow a group to be created and allow members to be added, removed and joined. A copy of the domain group is associated with each member job and indicates each job that is a member of a particular group. Management of a group is made by configuring each of the jobs of the group to assess its respective copy of the domain group in order to service requests, such as a request to join the group.

### CROSS-REFERENCE TO RELATED APPLICATIONS

This is a divisional of co-pending U.S. patent application Ser. No. 09/918,746 filed Jul. 31, 2001, which is herein incorporated by reference.

### BACKGROUND OF THE INVENTION

1. Field of the Invention

The present invention generally relates to distributed computer systems, and more particularly to a system and method for determining and managing group membership using domain groups.

2. Description of the Related Art

In typical computing systems, there is a predefined configuration in which a number of processors are defined. These processors may be active or inactive. Active processors receive applications to process and execute the applications in accordance with the system configuration. As databases and other large-scale software systems grow, the ability of a single computer to handle all the tasks associated with the database or large-scale software systems diminishes. Other concerns, such as failure handling and the response time under a large volume of concurrent queries, also increase the number of problems that a single computer must face when running a database program.

There are two ways to handle a large-scale software system. One way is to have a single computer with multiple processors running a single operating system as a symmetric multi-processing system. The other way is to group a number of computers together to form a cluster, a distributed computer system that works together as a single entity to cooperatively provide processing power and mass storage resources. Clustered computers may be in the same room, or separated by great distances. By forming a distributed computing system into a cluster, the processing load is spread over more than one computer, eliminating single points of failure that could cause a single computer to abort execution. Thus, programs executing on the cluster may ignore a problem with one computer. While each computer usually runs an independent operating system, clusters additionally run clustering software that allows the plurality of computers to process software as a single unit.

While clustering provides advantages for processing, clusters are difficult to configure and manage. For example, for a given cluster, a group or groups can be defined. A group is a collection of nodes (wherein each node is referred to as a member) which operate together to achieve a processing advantage (i.e., perform some task). Accordingly, it must be determined which members (i.e., nodes) of a cluster belong in a group. Group communication mechanisms have been used, but only provide the current membership of a group, not the intended membership. Further, existing methods of determining which members belong in a group are ad hoc, and can be difficult to manage.

One method of determining whether a member should be in the group is to use a key, or password. A key can be used to allow a processor or node to join a group. However, the key cannot change (i.e., the key is invariant) because if the key is changed, and a member is not in the group when the key changed, then that member will not be able to join the group.

Another problem with invariant keys is that the keys need to be kept in a place that any member can access. To this end, the key is either replicated on each member, or is stored in a global location. A replicated key, whether maintained by the member or an external server (e.g., Light-weight Directory Access Protocol (LDAP)), carries the risk that the key becomes lost. If a key is in a global location, the entire group is at the mercy of that location being available. In either case, if the key is unavailable, a member cannot join the group.

A second way to determine membership is simply include each and every cluster member in the group. This approach avoids the need to determine which node/processor is in the group and which isn't. However, in a geographically-dispersed cluster, this technique may not be performance practical because messaging across geographically-dispersed clusters can be expensive in terms of performance. Within a LAN it is possible to multicast messages, whereby a message is broadcast to all members. Outside of a common LAN it is necessary to send point-to-point messages to each member, in which case multiple sends are needed (one for each member).

A third way to determine group membership is to leave membership up to an administrator who can start up member jobs only when needed. The existence of the member indicates that it is to join the group. This is error-prone because the administrator has to manually manage a group's membership, and has some security risks in that someone else could start a job and so become a member.

In a fourth way to determine group membership a group could store member names in a global location, such as in a global file system. When a member wishes to join a group, that location is referenced to determine if the member name is in the file. If the name is not in the file, the member cannot join. However, since any member could join a group with any name it chooses, a name could be easily forged.

Finally, there exists a “first member problem” in determining and managing group membership. Each member that may be the first member in a group needs to have sufficient information to prevent expulsion of members incorrectly. When a group is started up, it has a membership of one, i.e., the member that first registers with the group. Particularly in a tightly-coupled cluster, such as one which is logically partitioned, when multiple nodes and members start simultaneously there is no sequencing of members. Thus, there is no guarantee that a particular member will be in the group first. Therefore, the first member either has to accept all joining members, or have enough information to know which members to accept or reject.

Therefore, there exists a need for a system and method that allows membership within a group of a cluster to be determined and managed.

### SUMMARY OF THE INVENTION

Embodiments of the present invention provide systems and methods for managing a membership of a group within a cluster.

In one embodiment, a method of managing membership of jobs executing on nodes in a cluster is provided. The method comprises providing a domain for each job of a group, wherein the domain indicates all jobs of the cluster with a membership to the group; and providing a set of interfaces configured to be invoked to manage the membership to the group.

In another embodiment, a method of managing the membership of jobs in a cluster comprises handling a request to create a group and a request to add a new job to the group. Upon receiving a request to create a group comprising at least two jobs, a list indicating each of the at least two jobs is created on the nodes on which the at least two jobs are running. Upon receiving a request to add a new job to the group, for each current member of the group, a respective list is updated to include the new job, while for the new node the list is replicated to the new job.

In yet another embodiment, a computer system comprises a first plurality of nodes. Each node comprises a processor configured to execute at least a first job and a memory device containing a copy of a first list. Each copy of the first list indicates a membership to a first group defined by the nodes on which the first job executes.

In yet another embodiment, a memory of a node in a cluster is provided, the memory containing at least a data structure. The data structure comprises a list defining membership to a group, wherein the list is replicated to each job having membership to the group and wherein each list is accessed upon each request from a requesting member job to join the group, wherein the request is granted if the requesting member job is indicated in each list of the other jobs of the group.

### BRIEF DESCRIPTION OF THE DRAWINGS

So that the manner in which the above recited features, advantages and objects of the present invention are attained and can be understood in detail, a more particular description of the invention, briefly summarized above, may be had by reference to the embodiments thereof which are illustrated in the appended drawings.

It is to be noted, however, that the appended drawings illustrate only typical embodiments of this invention and are therefore not to be considered limiting of its scope, for the invention may admit to other equally effective embodiments.

FIG. 1 depicts one example of a distributed computing environment incorporating the principles of the present invention;

FIG. 2 illustrates one example of a group in a cluster in accordance with the principles of the present invention;

FIG. 3 illustrates an exemplary hardware configuration for one node in a clustered computer system;

FIG. 4 is a flow diagram illustrating a Create_Group protocol;

FIG. 5 is a flow diagram illustrating an Add_Member protocol;

FIG. 6 is a flow diagram illustrating a Remove_Member protocol; and

FIG. 7 is a flow diagram illustrating a Join_Member protocol.

### DETAILED DESCRIPTION OF THE PREFERRED EMBODIMENTS

Generally, embodiments of the invention relate to systems and methods for creating and managing membership of a group within a cluster. A cluster is defined as a group of systems or nodes that work together as a single system. Each system or node is assigned a member name, which is a cluster-assigned name. The member name can be a machine's network host name, for example. A set of interfaces is provided that allows a cluster and a group to be created and allows members to be added, removed or joined. Generally, the systems and methods include a domain group which is a persistent object containing a list of the intended membership. The domain group object is stored as a persistent object on each member within the group. In general, a member refers to a job, and a group is a set of nodes executing the same job having the same name. However, it is understood that membership may be at any level including at the job level, the processor level and/or the system level. Thus, for example, a member may be a job, and a group may be a set of jobs running on a set of nodes. Which level is being addressed will be clear from context, if not stated explicitly.

In one embodiment, a mechanism is provided for joining a group in a distributed computing environment. A job requests to join a group, which includes the same job executing on another node(s), and that job is added to the group. In a further example, a job is removed from the group of jobs when the job requests to leave or when the node on which the job is running is removed from the cluster.

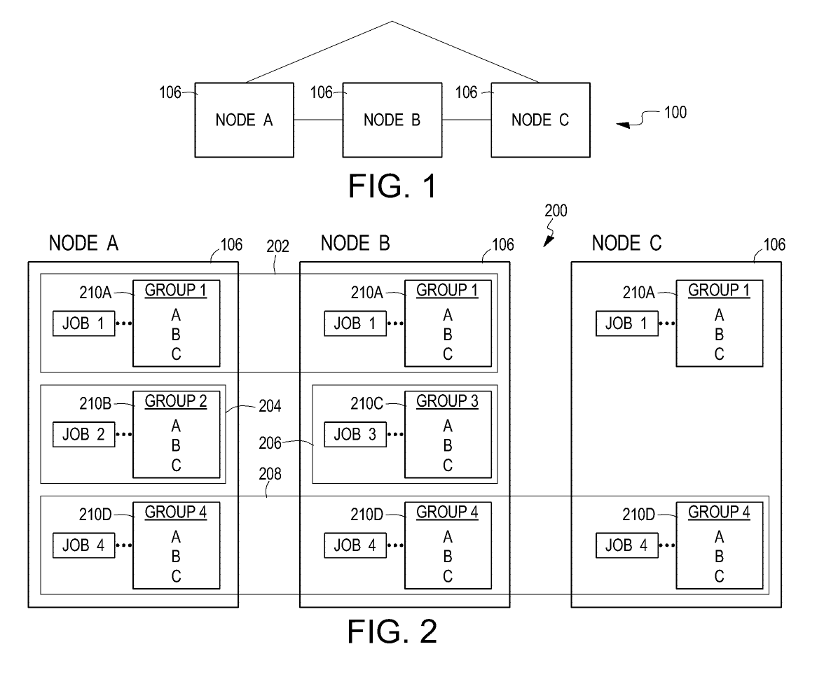

Embodiments of the invention can be implemented as a program product for use with a computer system such as, for example, the distributed system shown in FIG. 1 and described below. The program(s) of the program product defines functions of the embodiments (including the methods described below) and can be contained on a variety of signal-bearing media. Illustrative signal-bearing media include, but are not limited to: (i) information permanently stored on non-writable storage media (e.g., read-only memory devices within a computer such as CD-ROM disks readable by a CD-ROM drive); (ii) alterable information stored on writable storage media (e.g., floppy disks within a diskette drive or hard-disk drive); or (iii) information conveyed to a computer by a communications medium, such as through a computer or telephone network, including wireless communications. The latter embodiment specifically includes information downloaded from the Internet and other networks. Such signal-bearing media, when carrying computer-readable instructions that direct the functions of the present invention, represent embodiments of the present invention.

In general, the routines executed to implement the embodiments of the invention, whether implemented as part of an operating system or a specific application, component, program, module, object, or sequence of instructions may be referred to herein as a “program.” The computer program typically is comprised of a multitude of instructions that will be translated by the native computer into a machine-readable format and hence executable instructions. Also, programs are comprised of variables and data structures that either reside locally to the program or are found in memory or on storage devices. In addition, various programs described hereinafter may be identified based upon the application for which they are implemented in a specific embodiment of the invention. However, it should be appreciated that any particular program nomenclature that follows is used merely for convenience, and thus the invention should not be limited to use solely in any specific application identified and/or implied by such nomenclature.

In one embodiment, the techniques of the present invention are used in distributed computing environments in order to provide multi-computer applications that are highly available. Applications that are highly-available are able to continue to execute after a failure. That is, the application is fault-tolerant and the integrity of customer data is preserved.

It is important in highly-available systems to be able to coordinate, manage and monitor changes to groups defined within the distributed computing environment. In accordance with the principles of the present invention, a facility is provided that implements the above functions. One example of such a facility is referred to herein as Cluster Resource Services.

Cluster Resource Services is a system-wide, fault-tolerant and highly-available service that provides a facility for coordinating, managing and monitoring jobs running on one or more processors of a distributed computing environment. Cluster Resource Services, through the techniques of the present invention, provides an integrated framework for designing and implementing fault-tolerant jobs and for providing consistent recovery of multiple jobs.

As described above, in one example, the mechanisms of the present invention are included in a Cluster Resource Services facility. However, the mechanisms of the present invention can be used in or with various other facilities, and thus, Cluster Resource Services is only one example. The use of the term “Cluster Resource Services” to include the techniques of the present invention is for convenience only.

In one embodiment, the mechanisms of the present invention are incorporated and used in a distributed computing environment 100, such as the one depicted in FIG. 1. The distributed computing environment 100 defines a cluster which is a group of computer systems working together on different pieces of a problem. In particular, the distributed computing environment 100 provides for a predefined group of networked computers/nodes (three shown) that can share portions of a larger task. In one embodiment, the distributed computing environment 100 may be representative of the Internet, or a portion of the Internet. More generally, the distributed system 100 is representative of any local area network (LAN) or wide area network (WAN).

In the example shown, distributed computing environment 100 includes three processing nodes 106 (Node A, Node B and Node C). Each processing node is, for instance, an eServer iSeries computer available from International Business Machines, Inc. of Armonk, N.Y. The processing nodes are connected to one another to allow for communication. The connections between the nodes 106 represent logical connections, and the physical connections can vary within the scope of the present embodiments so long as the nodes 106 in the distributed computing environment 100 can logically communicate with each other. Connecting computers together on a network requires some form of networking software. Networking software typically defines a protocol for exchanging information between computers on a network. Many different network protocols are known in the art. Examples of commercially available networking software include Novell NetWare and Windows NT, which each implement different protocols for exchanging information between computers. One particular protocol which may be used to advantage is Transmission Control Protocol/Internet Protocol (TCP/IP).

The distributed computing environment of FIG. 1 is only one example. It is possible to have more or less than three nodes. Further, the processing nodes do not have to be eServer iSeries computers. Some or all of the processing nodes can include different types of computers and/or different operating systems.

Two or more of the nodes 106 of the distributed computing environment 100 may define a cluster. Further, within a cluster, one or more “groups” may be defined. A group corresponds to a logical grouping of a member or members. In one embodiment, a “member” is a job executing on one or more of the nodes within the cluster. The concepts of groups and members may be further described with reference to FIG. 2.

FIG. 2 shows a cluster 200 comprising three nodes 106, Node A, Node B, and Node C, which were initially described with reference to FIG. 1. The nodes each show at least one job executing thereon. Illustratively, Node A is executing Job 1, Job 2 and Job 4, Node B is executing Job 1, Job 3 and Job 4, and Node C is executing Job 1 and Job 4. Each job may be a member of a group. In one embodiment, a group is related according to the common jobs executing on respective nodes. For example, Job 1 on Node A and Job 1 on Node B are members of a first group 202. The instances of Job 1 on their respective nodes are differentiated by virtue of the respective node's name, which is unique within the cluster 200. Illustratively, a second group 204, a third group 206 and a fourth group 208 are also shown. For each group, the intended group membership is defined by a domain 210A-D (also referred to herein as domain group object). The domains 210A-D are collectively referred to herein as domains 210. In one embodiment, the domains 210 are implemented as persistent objects. A job is considered to have membership of a group when it is configured with a domain 210 indicating membership of the group. Illustratively, the instances of Job 1 on Nodes A and B are configured with a domain group object 210A indicating membership to the first group 202. Job 1 running on Node C also has membership to the first group 202 as indicated by the associated domain group object 210A of Node C. However, Job 1 on Node C is not currently an active member. This may be, for example, because the Job 1 on Node C failed and has since been restarted, but Job 1 running on Node C has not yet rejoined the first group 202.

In some cases, a node may be neither an active member of a group nor have membership with group. Job 1 running on Node C, for example, is not a member of the second group 204 nor does it have membership with the second group 204. However, Job 1 on Node C may be eligible to acquire membership with the second group 204. In one embodiment, a job is eligible for membership in a group if the job is running on a node that is part of a cluster that includes the other nodes executing jobs of the group. Thus, because Job 1 on Node C is member of the cluster 200, it is eligible to be a member of the second group 204 (as well as the third group 206).

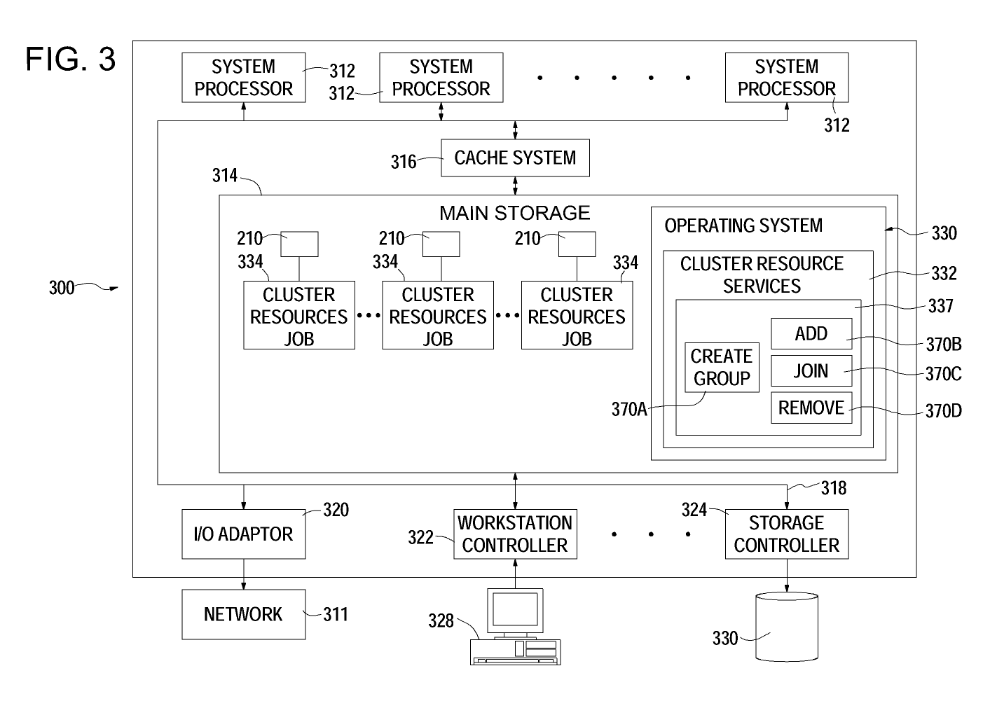

To implement the group management embodiments of the current invention, each node is configured with a Cluster Resource Services component. The Cluster Resource Services component facilitates, for instance, communication and synchronization between jobs of a node and governs the membership of jobs in groups of a cluster. The constituents of a node, and in particular the Cluster Resource Services component, are discussed in more detail below with reference to FIG. 3.

FIG. 3 is an exemplary hardware configuration and logical view for one of the nodes in the cluster 200. Node 300 generically represents, for example, any of a number of multi-user computers such as a network server, a mid range computer, a mainframe computer, etc. However, it should be appreciated that the invention may be implemented in other computers and data processing systems, e.g., in stand-alone or single-user computers such as workstations, desktop computers, portable computers, and the like, or in other programmable electronic devices (e.g., incorporating embedded controllers and the like).

Node 300 generally includes one or more system processors 312 coupled to a main storage 314 through one or more levels of cache memory disposed within a cache system 316. Furthermore, main storage 314 is coupled to a number of types of external devices via a system input/output (I/O) bus 318 and a plurality of interface devices, e.g., an input/output adaptor 320, a workstation controller 322 and a storage controller 324, which respectively provide external access to one or more external networks (e.g., a cluster network 311), one or more workstations 328, and/or one or more storage devices such as a direct access storage device (DASD) 330. Any number of alternate computer architectures may be used in the alternative.

To implement intended groups with embodiments of the invention, each node in a cluster typically includes a clustering infrastructure to manage the clustering-related operations on the node. For example, node 300 is illustrated as having resident in main storage 314 an operating system 330 implementing a cluster infrastructure referred to as clustering resource services 332. One or more cluster resource jobs 334 are also illustrated, each having access to the clustering functionality implemented within clustering resource services 332. Each cluster resource job 334 has associated with it a domain group object 210, which has been described above. The cluster resource job 334 assists in managing the domain group objects 210 on behalf of the node 300.

In general, the clustering resource services 332 is a layer of the operating system 330 that manages the cluster and its infrastructure. Illustratively, the clustering resource services 332 implements communication, messaging, the membership of the cluster and the membership of groups within the cluster. For the purpose of managing the membership of groups within the cluster, the clustering resource services 332 is configured with a set of interfaces 337. The interfaces include a Create_Group interface 370A, an Add_Member interface 370B, a Join_Member interface 370C, and a Remove_Member interface 370D, and their respective functions will be described in detail below.

It will be appreciated, however, that the functionality described herein may be implemented in other layers of software in node 300, and that the functionality may be allocated among other programs, computers or components in clustered computer system 100 and/or cluster 200. Therefore, the invention is not limited to the specific software implementation described herein.

In operation, a cluster, such as the cluster 200, is first created. The cluster is created by a user who specifies the list of nodes to be in a cluster as well as the addresses (e.g., IP addresses) for a cluster to communicate on. Once the cluster is defined, one or more groups can be created. In one embodiment, a group is created through using the Create_Group interface 370A, which is invoked for each request to create a group. The first job initially creating a group will create the domain object for the group. The object can then be updated to include other jobs and then replicated to (copied to) the other nodes/jobs using the Add_Member interface 370B. Once a job is configured with an object, it is considered to have membership in the group defined by the object. If it is currently an active part of the defined group, then it is said to be a member. A job having membership of a group, but not currently an active member of the group, can join the group using the Join_Group interface 370C. A job which is currently an active member can leave a group using the Remove_Member interface 370D.

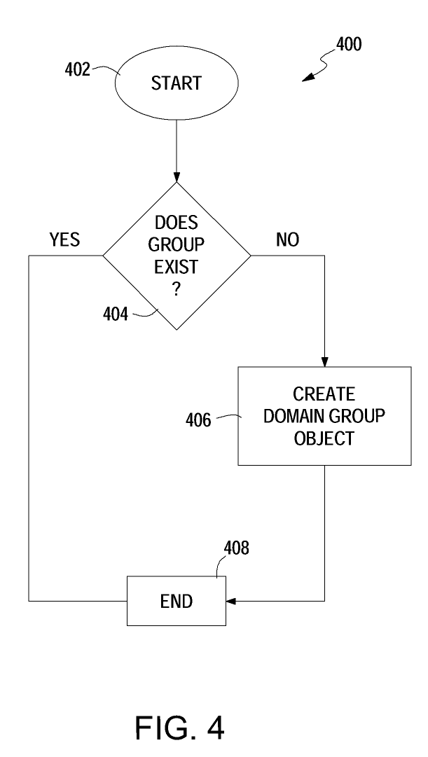

FIG. 4 shows a method 400 illustrating use of the Create_Group interface 370A. This method 400 runs on each job specified in a create request. The method 400 enters at step 402 and then proceeds to step 404 where it is determined whether a group exists. Initially, a group does not exist so at step 406 the job must create a domain group object 210. The domain group object indicates which group members will be able to join the group. Thus, the domain group object created at step 406 includes each job specified by the create request (i.e., the member names are passed in as parameters to the method 400). The domain group object 210 must be named and must be unique within the cluster. The method 400 then ends at step 408. After a group has been created, a subsequent job inquiring about the existence of a group at step 404 determines that a group has been created and the method 400 ends at step 408.

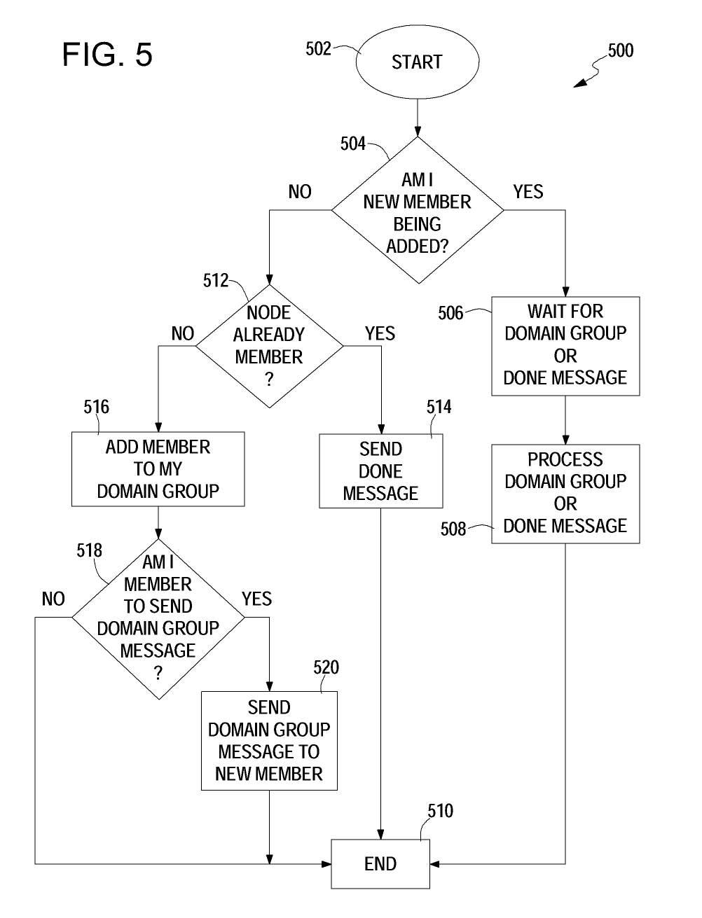

FIG. 5 shows a method 500 illustrating the Add_Member interface 370B. The method 500 runs on each job in the group membership, including the new job to be added. For example, with reference to FIG. 2, assume that a job executing on Node C wants to acquire membership and be added to the second group 204. In this case, Job 2 on Node A and the job on Node C requesting to be added (not shown) execute method 500. The method 500 enters at step 502 and proceeds to step 504 where the job executing the method 500 queries whether it is the new member being added. If so, the method 500 proceeds to step 506. Otherwise, the method 500 proceeds to step 512.

If the job running the Add_Member interface 370B is not the new member being added, then at step 512 the job inquires whether the prospective new member is already a member of the group. This may be done by referencing the domain group object 210 to determine whether the prospective new member is contained therein. If the new member being added is already a member, then a done message is generated and sent to the new member at step 514. If the new member being added is not already a member, then the existing member running the method 500 adds the member being added to its domain group object 210 at step 516. In one embodiment, the new member is only added to the domain group object 210 if certain criteria are satisfied. Generally, the job being added need only be approved by the cluster. Thus, if the job being added is part of the cluster, it can become a new member of a group of the cluster. It should be noted that this is true only if the member is seeking to be added; that is, if the member is new to the group and is not simply a job having membership seeking to rejoin a group. The latter situation is handled by the Join_Member interface 370C, described below.

After the new member is added to the domain group, the existing job(s) executing method 500 inquires, at step 518, whether it is responsible for sending a domain group message to the new member. This determination can be made according to a user-assigned weight or otherwise determined. If the job is responsible to send the group message, then a domain group message is generated and sent to the new member at step 520. The method 500 then ends at step 510.

Returning to step 504, if the job executing the method 500 is the job to be added as a new member, processing proceeds to step 506 where the job waits for a copy of the domain group object 210 or a “done” message (sent by the existing job(s) at steps 514 and 520, respectively). The appropriate response is then processed at step 508 and the method 500 ends at step 510.

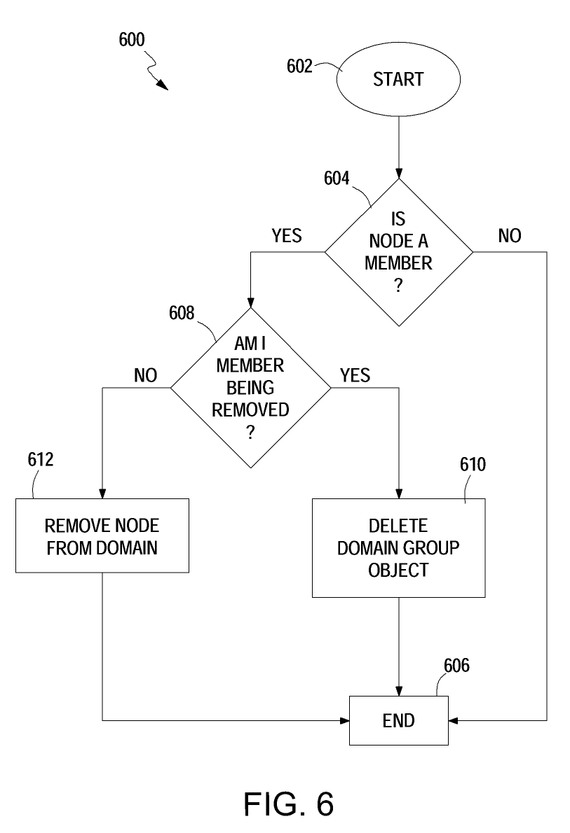

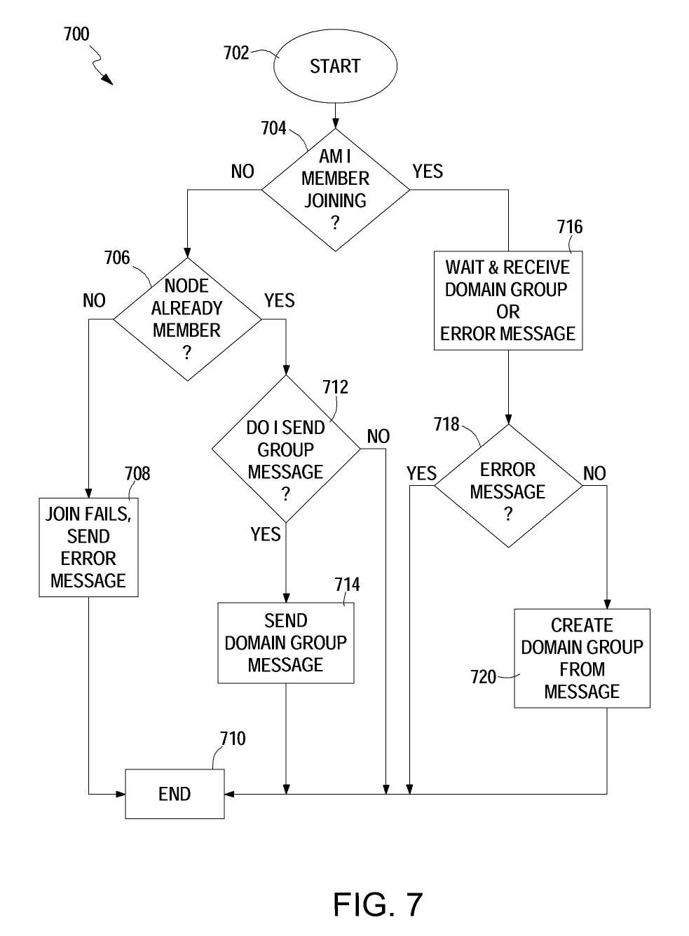

A member of a group can be removed from the group by the Remove_Member interface 370D. A method 600 illustrating the Remove_Member interface 370D is shown in FIG. 6. This method 600 runs on all jobs having membership of a group and is entered at step 602. The initial inquiry at step 604 is whether the job being removed is a member. If not, the method 600 ends at step 606. If the job being removed is a member, each job running the method 600 queries, at step 608, whether it is the member being removed. The job being removed then has its copy of the domain group object 210 deleted at step 610. After the domain group object 210 is deleted, the method 600 ends at step 606. If, at step 608, the job determines that it is not the member being removed, then the job removes the member being removed from its domain group object 210 at step 612. The method 600 then ends at step 606.

A job having membership can rejoin a group through the Join_Member interface 370C. A method 700 illustrating the Join_Member interface 370C is shown in FIG. 7. This method runs after a member in a group is restarted after a member failure or a system failure, for example. For example, Node C of FIG. 2 is executing Job 1 and the domain group objects 210A indicate that Job 1 has membership with the first group 202. However, as shown, Job 1 is not currently an active member in the first group 202. To join the first group 202, the Join_Member interface 370C is invoked and executed on Job 1 of Nodes A-C.

For a given job, method 700 enters at step 702 and proceeds to step 704 to query whether the given job is the member joining. If so, processing proceeds to step 716. If the given job executing method 700 is not the job being joined, then a processing proceeds to step 706.

At step 706, an inquiry is made whether the job requesting to be joined is already a member. If not, the join method 700 fails and an error message is generated and sent to the group rejecting the join attempt as indicated by step 708. Thereafter, the join method ends at step 710. If job requesting to be joined is already a member, the join is successful and the job inquires at step 712 whether it should send a group message indicating the successful join. This may be determined according to a user-assigned weight or by other methods set by an operator. After the group message is sent at step 714 or if the job making the inquiry at step 712 is not configured to send the message, the method 700 on this job is ended at step 710.

Returning to step 704, if the job executing the method 700 is the member requesting to join, processing proceeds to step 716 where the job waits and receives a response from an active member of the group. The response is either the domain group message sent at step 714 in the case of a successful join or the error message sent at step 708 in the case of a failed join. At step 718, the job queries whether the received message is the error message. If so, the method 700 ends at step 710. If, on the other hand, the message is the domain group message, a domain group object is created on the joining job at step 720. The method 700 then ends at step 710.

It should be noted that a member of a group can be ended without taking the associated node out of the cluster. Thus, when a member is ended, the member is marked as inactive in the group. No protocols are run on the member while it is inactive. When the member is restarted, it will attempt to rejoin the group via the Join_Member interface 370C in the manner described above. If a member is inactive and will never become active again, the member may be removed using the Remove_Member interface 370D in the manner described above.

While the foregoing is directed to embodiments of the present invention, other and further embodiments of the invention may be devised without departing from the basic scope thereof, and the scope thereof is determined by the claims that follow.

What is claimed is:

1. A method of managing membership of members in a cluster, comprising:
providing a domain for each member of a group, wherein the domain indicates all members of the cluster with a membership to the group; and
providing a set of interfaces configured to be invoked to manage the membership to the group, wherein at least one interface, when invoked by a request of a requestor, causes each member of the group to access its respective copy of the domain to determine whether the requestor is indicated in its respective copy of the domain.

2. The method of claim 1, wherein the request is to join the requestor to the group.

3. The method of claim 1, wherein providing the set of interfaces comprises providing a Join_Member interface which is invoked when an inactive member requests to join the group, and wherein the Join_Member interface, when invoked, causes an active member currently in the group to access its copy of the domain to determine whether the inactive member has membership with the group.

4. The method of claim 1, wherein providing the set of interfaces comprises providing a first interface invoked by a request to add a potential member to the group, a second interface invoked by a request to join an inactive member to the group, and a third interface invoked by a request to remove a member from the group.

5. The method of claim 1, wherein the domain is a unique persistent object in the cluster.

6. The method of claim 1, wherein the members are jobs running on nodes of the cluster.

7. The method of claim 6, wherein the members are differentiated by unique names of a respective node on which they are running.
